(19) United States
(12) Patent Application Publication
(10) Pub. No.: US 2013/0097884 A1
(43) Pub. Date: Apr. 25, 2013

(54) Hand tool for sizing hardware fasteners

(71) Applicant: Richard D. Hayworth, Lake Havasu City, AZ (US)

(72) Inventor: Richard D. Hayworth, Lake Havasu City, AZ (US)

(21) Appl. No.: 13/278,168

(22) Filed: Oct. 20, 2011

(51) Int. Cl. G01B 3/16

(52) U.S. Cl. 33/808

(57) ABSTRACT

A hand tool that can measure standard or metric hardware fasteners. By opening the tool and closing it on the nut or fastener, it will show the correct size of the fastener on a two sided graduated scale, one side for standard sizes and the other for metric, which is intergraded into the tool. The tool has a locking mechanism that can insure accurate measurement after the tool is removed from the fastener. The tool is compact to be able to reach hard to reach work areas.

### FIELD OF INVENTION

This invention relates to hand tools and, more specifically, A hand tool that accurately measures hardware fastener sizes.

### BACKGROUND OF THE INVENTION

Hardware is classified as being either A.S.E. or Metric. When assembling or disassembling hardware, it is almost impossible to know what size wrench to use, especially when the item being worked on is in an area where you cannot see, it is difficult to know what size wrench to use without trial and error and having multiple sets of wrenches handy.

### SUMMARY OF THE INVENTION

This device eliminates the guesswork involved in finding the proper wrench and saves time in the process. You simply put the jaws of the device over the fastener, lock the thumbwheel and remove the device from the fastener and look on the built in scale to see what size the fastener is. At that point, you can find and use the appropriate wrench to assemble or disassemble the fastener.

### BRIEF DESCRIPTION OF DRAWINGS

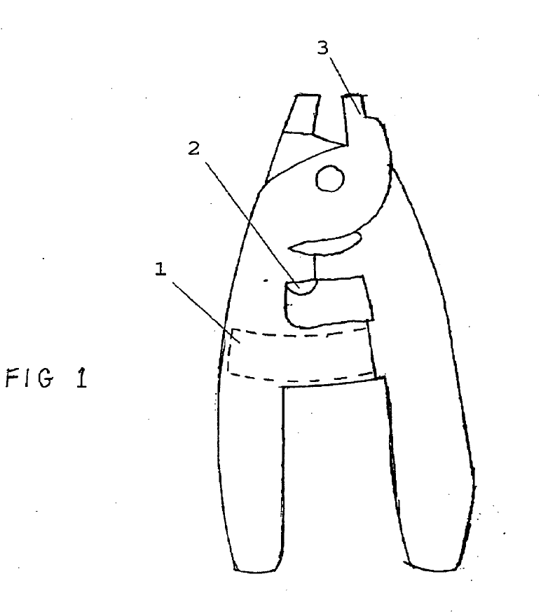

1. FIG. 1 shows one side of the device.
a) #1 shows the graduated scale hidden by the pointer
b) #2 shows the thumbwheel locking mechanism that locks measurements
c) #3 shows the narrow jaws that make it possible to use the device in confined spaces

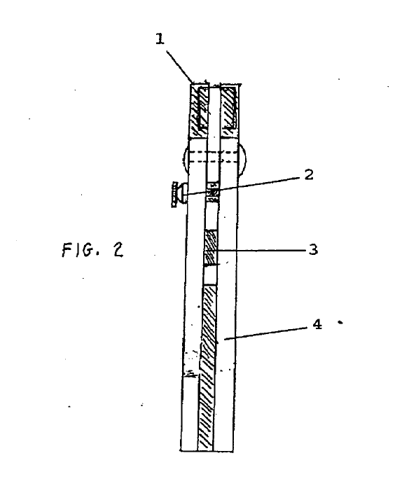

2. FIG. 2 shows a side view of the device
a) # 1 shows the wide jaws for accurate measurement of fastener
b) #2 shows the protected locking mechanism
c) #3 shows protected measuring scales
d) #4 shows the reinforced handle

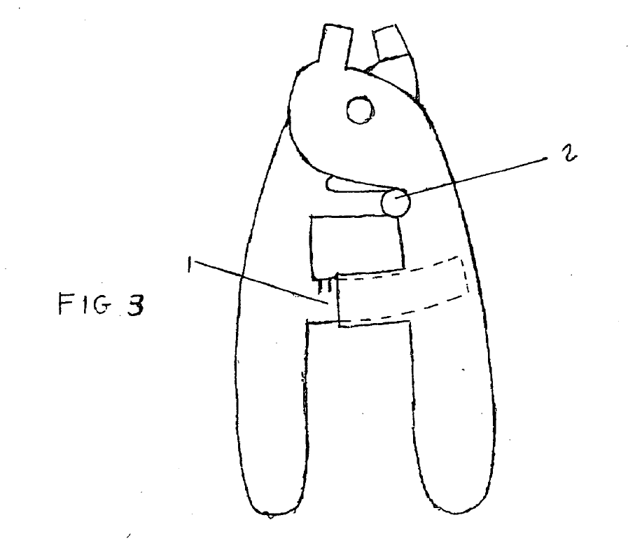

3. FIG. 3 shows the other side of the device
a) #1 shows the tapered jaws of the device
b) #2 shows the locking thumbscrew for tension adjustment

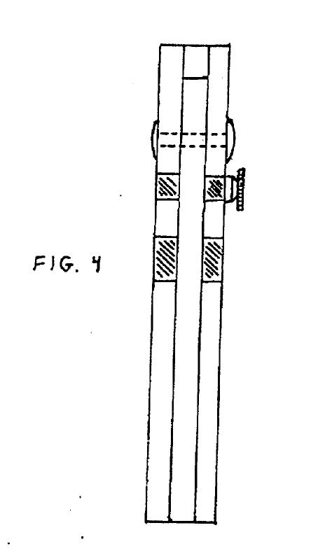

4. FIG. 4 shows the other side of FIG. 1

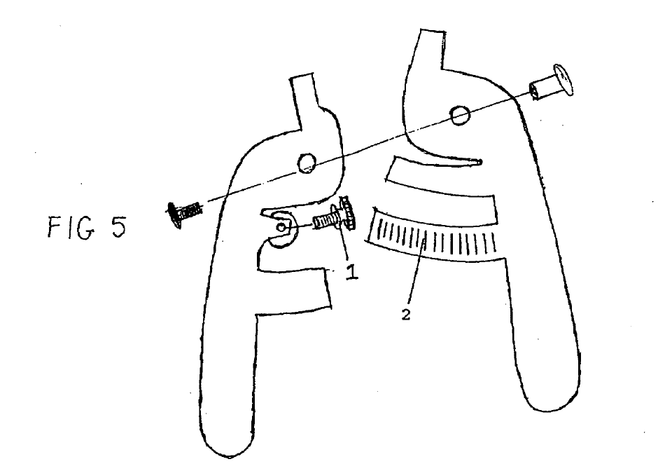

5. FIG. 5 shows an exploded view of the device
a) #1 shows the barrel bolt locking mechanism for tension adjustment
b) #2 shows the graduated measuring scale

What is claimed is:

1. A handheld tool that can measure hardware fasteners of any size with little effort.

2. The device will time hunting for the proper sized wrench or socket.

3. Because the device measures standard and metric sizes, there is no need for another tool to measure different sized fasteners.

4. The device has a locking mechanism to insure that measurements are not lost.

5. The size and shape of the device makes it easy to use in confined spaces.
